(19) United States
(12) Patent Application Publication
(10) Pub. No.: US 2026/0288383 A1
(43) Pub. Date: Sep. 24, 2026

(54) PRINTING SYSTEMS, PRINT PROCESSING APPARATUSES, AND CONTROL METHODS THEREFOR

(71) Applicant: CANON KABUSHIKI KAISHA, Tokyo (JP)

(72) Inventor: KIYOKAZU UMIMURA, Chiba (JP)

(21) Appl. No.: 19/569,909

(22) Filed: Mar. 17, 2026

(30) Foreign Application Priority Data
Mar. 19, 2025 (JP) 2025-046054

(51) Int. Cl. G06F 3/12

(52) U.S. Cl. CPC G06F 3/1204; G06F 3/1221; G06F 3/1229; G06F 3/128

(57) ABSTRACT

One or more printing systems, apparatuses, methods, and storage mediums are provided herein. In a printing system, it has been difficult for a user to turn on power of a print processing apparatus by operating a power switch of an image forming apparatus. At least one control method is provided for a print processing apparatus including a second power controller to which an output of a first power switch of an image forming apparatus and an output of a second power switch are connected via a switch controller. The control method includes performing control, by the second power controller, to turn on power of the print processing apparatus based on the second power controller detecting that either the first power switch or the second power switch has been turned on.

### BACKGROUND

### Field of the Technology

The present disclosure relates to one or more embodiments of printing systems including a print processing apparatus and an image forming apparatus, one or more embodiments of print processing apparatuses, and one or more embodiments of control methods therefor.

### Description of the Related Art

Conventionally, there has been a print processing apparatus such as an external print server connected one-to-one to an image forming apparatus such as a multifunction peripheral.

A multifunction peripheral to which a print server is connected becomes able to perform printing processing even for data written in a printing language such as a page description language (PDL) that is not supported by the multifunction peripheral itself. Therefore, an external print server needs to process a large amount of data at a high speed, and unlike a general multifunction peripheral, a personal computer (PC)-based design including a high-performance central processing unit (CPU), a motherboard, and the like is used.

Further, since such a print server is PC-based, there is generally a case where the print server is started and used as a standalone device independently of the multifunction peripheral. For example, a client PC can access an operating print server via a network, and can re-edit a print job already sent to the print server, change finishing settings, and the like.

Meanwhile, in such a printing system in which a multifunction peripheral and an external print server are connected, there is a case where the external print server is incorporated into, and integrated with, the back side or the like of the multifunction peripheral due to installation constraints. As a result, to access a power switch of the print server, a user needs to move to the back side of the multifunction peripheral, and convenience is impaired.

In view of the above situation, there is a demand to turn the power on/offwithout accessing the power switch of the print server.

As a method for satisfying the demand, a technique is generally known in which, when a power switch of a multifunction peripheral is turned on, a power control unit of the multifunction peripheral accesses a power control unit of a print server using a control line of the power control unit in the multifunction peripheral to supply power to the print server and thereby start the print server (see Japanese Patent Laid-Open No. 2019-200514).

However, in the technique disclosed in Japanese Patent Laid-Open No. 2019-200514, since the power of the print server is turned on by a control signal output after completion of startup of the multifunction peripheral, there is an issue that a startup time of an entire system becomes long.

### SUMMARY

According to one or more aspects of the present disclosure, one or more embodiments of a printing system may include an image forming apparatus including a first power controller connected to a first power switch, and a print processing apparatus in which a second power switch is connected to a second power controller via a switch controller, wherein the second power controller is connected to the second power switch and the first power switch via the switch controller, and wherein the second power controller is configured to, based on detecting that either the second power switch or the first power switch has been turned on, execute control to turn on power of the print processing apparatus.

According to other aspects of the present disclosure, one or more additional image printing systems, one or more printing apparatuses, one or more control methods therefor, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating at least one embodiment of a hardware configuration of a printing system that may be used in one or more embodiments or one or more additional embodiments in accordance with one or more aspects of the present disclosure.

FIG. 2 is a block diagram illustrating at least one embodiment of a hardware configuration of a print server in accordance with one or more aspects of the present disclosure.

FIG. 3 is a block diagram illustrating at least one embodiment of a hardware configuration of a multifunction peripheral (MFP) in accordance with one or more aspects of the present disclosure.

FIG. 4 is a circuit diagram illustrating at least one embodiment of a circuit configuration of a switch control unit or controller of the print server in accordance with one or more aspects of the present disclosure.

FIG. 5 is a timing chart illustrating at least one embodiment of an operation of the switch control unit or controller of the print server in accordance with one or more aspects of the present disclosure.

FIG. 6 is a circuit diagram illustrating at least one embodiment of a circuit configuration of a switch control unit or controller in accordance with one or more aspects of the present disclosure.

FIG. 7 is a timing chart illustrating at least one embodiment of an operation of the switch control unit or controller in accordance with one or more aspects of the present disclosure.

### DESCRIPTION OF THE EMBODIMENTS

Embodiments for carrying out the present technique will be described below with reference to the drawings. However, constituent elements described in the embodiments below are merely examples, and the scope of the present disclosure is not intended to be limited to only those constituent elements.

### ONE OR MORE EMBODIMENTS

### Hardware Configuration(s) of One or More Embodiments

### (Overall Configuration(s) of One or More Embodiments)

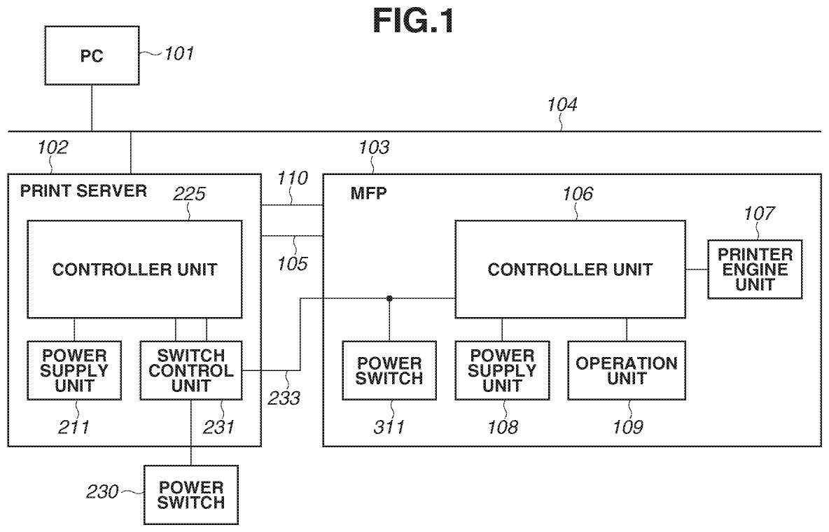

An overall configuration of a printing system according to one or more embodiments (or one or more additional embodiments) of the present disclosure will be described with reference to FIG. 1.

One or more embodiments provide at least one method for turning on/off power of a print server in conjunction with a power switch of an image forming apparatus.

In one or more embodiments, a print server 102 will be described as an example of a print processing apparatus, a multifunction peripheral (MFP) 103 will be described as an example of the image forming apparatus, and a client personal computer (PC) 101 will be described as an example of an information processing apparatus.

In FIG. 1, the PC 101, the print server 102, and the MFP 103 are communicably connected to each other via a local area network (LAN) 104. Further, the print server 102 and the MFP 103 are connected to each other via a cable 105 and a network cable 110.

In accordance with an operation of a user, the PC 101 generates a print job including data written in a printing language such as a page description language (PDL) or data in a specific data format (compressed by Joint Bi-level Image Group (JBIG) or the like). The PC 101 transmits the print job to the print server 102 serving as the print processing apparatus.

Upon receiving the print job from the PC 101, the print server 102 performs image rendering processing on the print job to generate rasterized data.

Further, the PC 101 is configured to remotely access the print server 102 via the LAN 104, and the PC 101 is configured to operate the print server 102.

The print server 102 transmits print data based on the rasterized data to the MFP 103 serving as the image forming apparatus via the cable 105 or the network cable 110, and the MFP 103 serving as the image forming apparatus executes printing based on the print data.

Further, a switch control unit 231 of the print server 102 detects an OFF/ON state of a power switch 311 of the MFP 103 using a control line 233, and turns off/on power of the print server 102 in conjunction with the MFP 103 serving as the image forming apparatus.

### Print Server that May be Used in One or More Embodiments

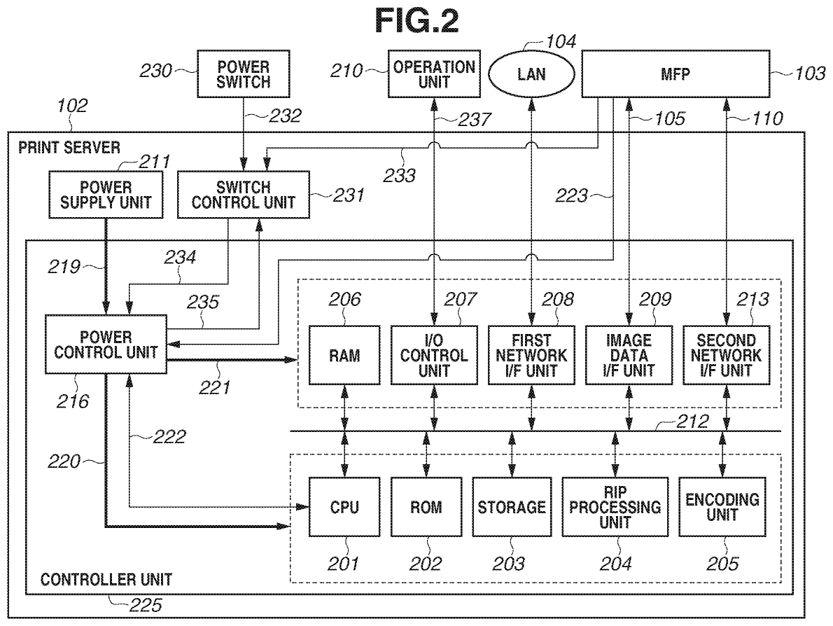

FIG. 2 is a block diagram illustrating at least one embodiment of a control configuration of the print server 102 serving as the print processing apparatus.

A central processing unit (CPU) 201 controls an entirety of the print server 102.

A read only memory (ROM) 202 stores a boot program executed by the CPU 201.

A storage 203 temporarily stores (spools) system software, image data, a software counter value, a print job received by a first network I/F unit 208, and the like. The storage 203 is, for example, a hard disk drive (hereinafter referred to as an “HDD”) or a solid-state drive (hereinafter referred to as an “SSD”).

A raster image processor (RIP) processing unit 204 rasterizes received data written in a printing language such as a PDL or received data in a specific data format (compressed by JBIG, Modified READ (MR), Modified Modified READ (MMR), Modified Huffman (MH), or the like).

An encoding unit 205 converts the rasterized data into print data or a data format supported by the MFP 103.

A random access memory (RAM) 206 is used by the CPU 201 as a temporary data storage area, and the RAM 206 is also used when the RIP processing unit 204 performs image rendering processing.

An input/output (I/O) control unit 207 connects the present system and an external device or the like. The I/O control unit 207 is connected, via a cable 237, to an operation unit 210 used by a user to operate the present system. A general input device (not illustrated) such as a mouse or a keyboard may also be connected.

A first network interface (I/F) unit 208 controls a low-layer-level connection to the LAN 104.

An image data I/F unit 209 controls a connection to the cable 105 connected to the MFP 103.

The operation unit 210 is used by a user of the present system to operate the print server 102. In one or more embodiments, a general-purpose liquid crystal display (LCD) having a touch panel is assumed.

Since the print server 102 includes the RIP processing unit 204 and the encoding unit 205, the MFP 103 connected via the cable 105 or the network cable 110 becomes able to perform printing even for data written in a printing language that is not supported by the MFP 103.

The print server 102 causes the RIP processing unit 204 to perform image rendering processing on a print job to generate raster image data, and causes the encoding unit 205 to convert the raster image data into a data format supported by the MFP 103. The print server 102 transmits the converted data to the MFP 103 connected via the cable 105 through the image data I/F unit 209.

A power supply unit 211 supplies electric power to the print server 102.

A system bus 212 is connected to each module in the print server 102. Data processed by each module in the print server 102 is communicated between related modules via the system bus 212.

A second network I/F unit 213 is connected to the MFP 103 via the network cable 110, and controls a connection to the MFP 103.

A power control unit 216 controls ON/OFF of power on power supply lines 220 and 221 using a control line 223 indicating a state of the MFP 103 and a control line 222 through which a control signal of the CPU 201 is transmitted. When the operation unit 210 accepts an operation, the I/O control unit 207 receives a control signal via the control line 237, and an ON/OFF power control signal is notified to the power control unit 216 via the system bus 212 and the CPU 201. Further, when a wake-up packet or the like is received from the LAN 104, the first network I/F unit 208 receives the wake-up packet, and an ON/OFF power control signal is notified to the power control unit 216 via the system bus 212 and the CPU 201.

In a sleep state, the power control unit 216 does not supply power to a main portion of the print server 102, the print server 102 transitions to a power-saving state, and power consumed by the print server 102 is reduced.

In the present example, the main portion of the print server 102 serving as the print processing apparatus includes the CPU 201, the ROM 202, the storage 203, the RIP processing unit 204, and the encoding unit 205.

A portion other than the main portion of the print server 102 includes the RAM 206, the I/O control unit 207, the first network I/F unit 208, the image data I/F unit 209, the operation unit 210, and the second network I/F unit 213.

A power switch 230 switches an ON/OFF state of power of the print server 102. The power switch 230 is connected to the switch control unit 231 via a control line 232, and is connected to the power control unit 216 of the print server 102 via the switch control unit 231. A type of a switch used as the power switch 230 is a push switch.

The switch control unit 231 switches an ON/OFF state of power of the print server 102 using the power switch 230 and the power switch 311 of the MFP 103. Three types of signals are input to the switch control unit 231, namely, a signal on the control line 232 from the power switch 230, an ON signal 235 from the power control unit 216, and a signal on the control line 233 from the power switch 311 of the MFP 103.

### MFP that May be Used in One or More Embodiments

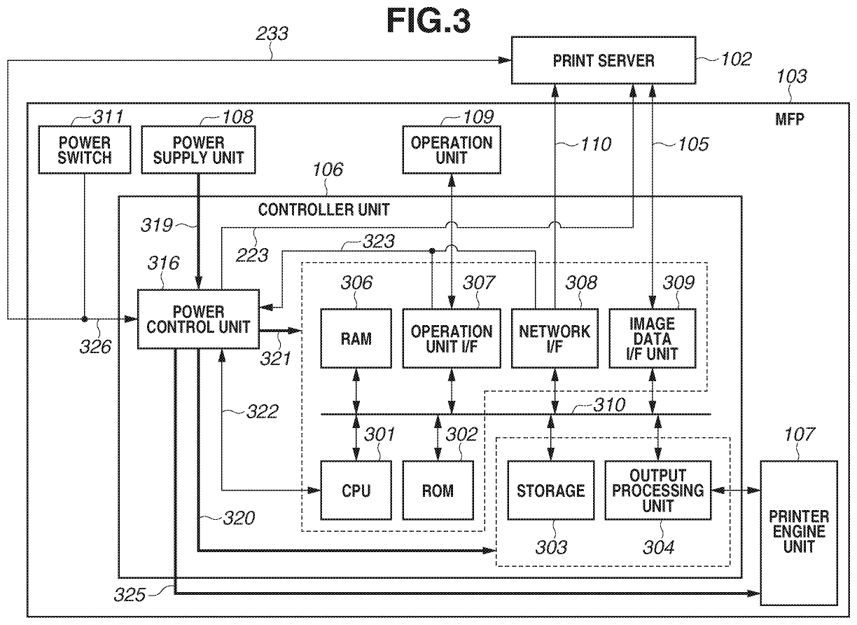

FIG. 3 is a block diagram illustrating at least one embodiment of a control configuration of the MFP 103.

A CPU 301 controls an entirety of the MFP 103.

An operation unit 109 includes an LCD, a touch panel, a numeric keypad, a power-saving key, and the like. A user performs an operation of the MFP 103 using the operation unit 109.

A ROM 302 stores a boot program executed by the CPU 301.

A storage 303 stores system software, print data, and programs, and is also used as a cache area for data. The storage 303 is, for example, an HDD or an SSD.

An output processing unit 304 performs processing such as gamma conversion, edge enhancement, and smoothing to correct image data sent from the CPU 301 into data suitable for printing on paper, and transfers an image to a printer engine unit 107.

A RAM 306 is used by the CPU 301 as a temporary data storage area, and is used when print image data is loaded or when print image data is processed.

An operation unit I/F 307 communicates with the CPU 301 and with an LCD, a touch panel, and a switch in the operation unit 109.

A network I/F 308 controls a low-layer-level connection to the LAN 104.

An image data I/F 309 receives data transmitted from the print server 102 via the cable 105, and spools the data to the storage 303.

A system bus 310 connects the CPU 301, the ROM 302, the storage 303, the output processing unit 304, the RAM 306, the operation unit I/F 307, the network I/F 308, and the image data I/F 309.

A power switch 311 is a switch operated by a user to turn on/off power of the MFP 103. When a switch operation is performed, the power switch 311 notifies, via a control line 326, a power control unit 316 that the switch operation has been performed. A control line 233 connected to the control line 326 is connected to the switch control unit 231 of the print server 102. Here, a type of a switch used as the power switch 311 is a rocker switch.

The power control unit 316 is connected to a control line 323 through which a sleep control signal from the operation unit I/F 307 and the network I/F 308 is transmitted, a communication line 322 through which a communication signal with the CPU 201 is transmitted, and the control line 326 from the power switch 311. The power control unit 316 controls ON/OFF of power on power supply lines 320, 321, and 325.

Accordingly, the power control unit 316 controls power of an entirety of the MFP 103.

Further, the power control unit 316 controls ON/OFF of a print-server power control signal 223.

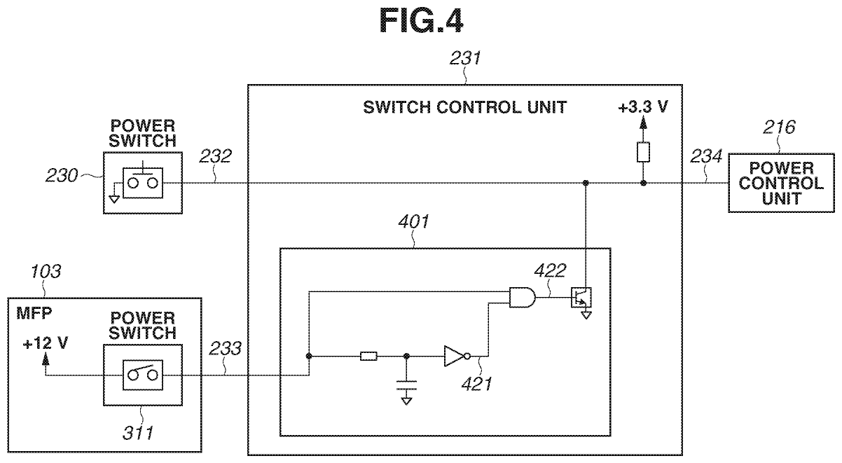

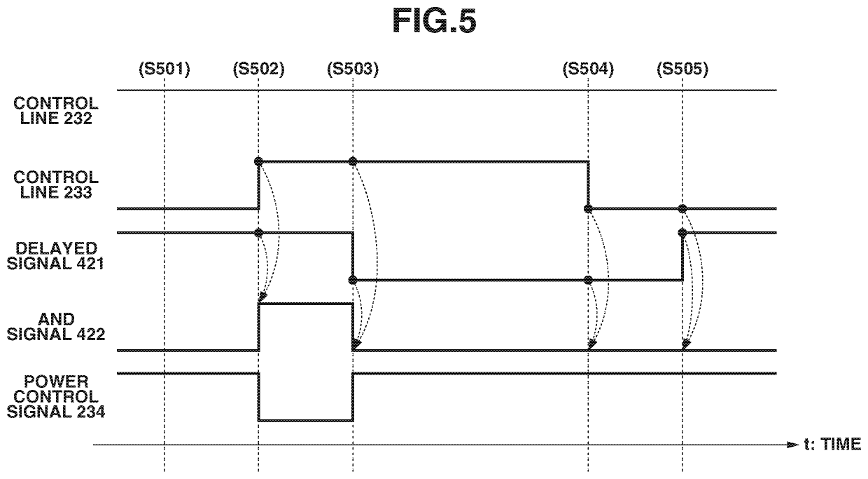

Based on the above description, a detailed description of the switch control unit 231 of the print server 102 will be provided with reference to FIG. 4 and FIG. 5.

### Switch Control Unit (Print Server) that May be Used in One or More Embodiments

FIG. 4 illustrates at least one embodiment example of a circuit configuration of the switch control unit or controller 231.

The power switch 230 of the print server 102 is a push switch. Since an input side of the power switch 230 is pulled down, while a user presses the power switch 230, the control line 232 of a switch signal output from the power switch 230 becomes “Low”. Conversely, since the control line 232 is pulled up to 3.3 [V] at a downstream side, when the push switch serving as the power switch 230 is not pressed, the control line 232 becomes “High”. By pressing and releasing the push switch, a pulse signal is generated, and the pulse signal is input as a power control signal 234. A power control unit 216 to which the power control signal 234 is input detects the pulse signal and turns on/off power of the print server 102. When the print server 102 is in an OFF state, the pulse signal from the power switch 230 is input as-is to the power control unit 216, and the print server 102 enters an ON state.

The power switch 311 of the MFP 103 is a rocker switch. Since an input side of the power switch 311 is pulled up to +12 [V], when a user turns on the power switch 311, states of the control line 326 and the control line 233, which are output from the power switch 311, are kept ON (“High”). In contrast, since the power control signal 234 from the switch control unit to the power control unit 216 of the print server 102 is for a push-switch operation, the signal on the control line 233 needs to be converted into a pulse signal.

An ON-pulse generation unit or generator 401 detects arising edge on the control line 233, and generates, with the rising edge as a starting point, an ON pulse signal having a width detectable by the power control unit 216.

To generate the ON pulse signal, the ON-pulse generation unit or generator 401 includes a delay circuit, a logic integrated circuit (IC), and a transistor. The delay circuit includes, for example, a resistor (R) and a capacitor (C), and provides, using a time constant (RC), a delay having a time width detectable by the power control unit 216, with the control line 233 as a starting point. In a subsequent logic-IC portion, a delayed signal is inverted by an inverter (NOT) to obtain an inverted delayed signal 421, and an AND operation is performed between a signal on the control line 233 and the inverted delayed signal 421 by AND logic to output an AND signal 422 to be a base input to the transistor. Accordingly, a pulse signal is generated. The generated pulse signal is connected, by the transistor, to the control line 232 serving as the switch signal output from the power switch 230 of the print server via a wired-OR connection, thereby forming the power control signal 234.

### Timing Chart of Switch Control Unit or Controller for One or More Embodiments or Additional Embodiments

A description will be provided for at least one embodiment of an operation of the switch control unit or controller 231 with reference to the timing chart of FIG. 5.

Step S501 indicates an initial state of the switch control unit 231. The power switch 230 is not pressed, and the control line 232 is “High”. A state of the power switch 311 is “OFF”, and the control line 233 is “Low”. The power control signal 234 serving as an output signal of the switch control unit 231 is “High”.

In step S502, a state of the power switch 311 serving as the rocker switch is switched from “OFF” to “ON” by a user operation. When the power switch 311 enters an ON state, the control line 233, which is an output of the power switch 311, becomes “High”, whereas the inverted delayed signal 421 remains “High” because the inverted delayed signal 421 is an inverter output in a state in which the control line 233 is “Low”. Accordingly, since two inputs of the AND logic both become “High”, the transistor is turned on, and therefore the power control signal 234 outputs “Low”.

Step S503 indicates a moment at which a predetermined time defined by the time constant (RC) has elapsed since the control line 233 became “High”. Here, since an input of the inverter becomes “High”, the inverted delayed signal 421 becomes “Low”. As a result, since an input of the AND logic becomes “Low”, the transistor is turned off, and the power control signal 234 becomes “High”. By this operation, a negative-logic ON pulse signal having a width detectable by the power control unit 216 is generated as the power control signal 234 with the rising edge of the control line 233 as a starting point.

In step S504, a state of the power switch 311 is switched from “ON” to “OFF” by a user operation. When the power switch 311 becomes “OFF”, the control line 233 becomes “Low”, whereas the inverted delayed signal 421 remains “Low” because the inverted delayed signal 421 is an inverter output in a state in which the control line 233 is “High”. Accordingly, since two inputs of the AND logic both become “Low”, the transistor is turned off, and the power control signal 234 is “High”.

In step S505, a predetermined time defined by the time constant (RC) has elapsed since the control line 233 became “Low”. Here, since an input of the inverter becomes “Low”, the inverted delayed signal 421 becomes “High”. However, since an input of the AND logic remains “Low”, the transistor remains off, and the power control signal 234 remains “High”.

By the above operation, an ON pulse signal having a width detectable by the power control unit 216 is generated as the power control signal 234 with a rising edge of the control line 233 as a starting point.

With the above configuration(s), an ON/OFF state of power of the print server 102 may be switched by the power switch 311 of the MFP 103. Accordingly, power of the MFP 103 and power of the print server 102 may be turned on at the same time.

### ONE OR MORE ADDITIONAL EMBODIMENTS

In the aforementioned one or more embodiments, the power switch 311 of the MFP 103 is a rocker switch, and turning on the power switch 311 is detected, and then the MFP 103 and the print server 102 are turned on at the same time. In one or more additional embodiments, a case where the power switch 311 of the MFP 103 is a push switch will be described.

### Circuit Diagram of a Switch Control Unit or Controller that May be Used in One or More Additional Embodiments

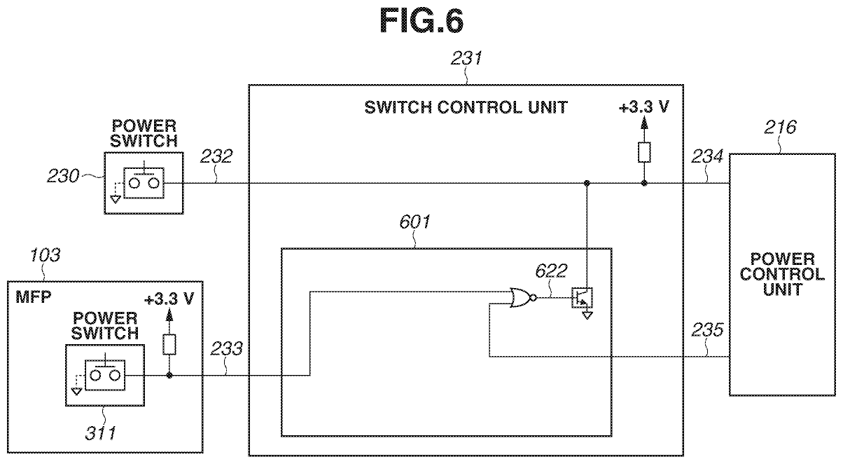

FIG. 6 illustrates at least one embodiment of a circuit configuration of the switch control unit or controller 231 that may be used in the aforementioned one or more embodiments or that may be used in one or more additional embodiments.

A power switch 311 of the MFP 103 is a push switch. Since an input side of the power switch 311 is pulled down, while a user presses the power switch 311, the control line 233 of a switch signal that is an output of the power switch 311 becomes “Low”. Conversely, since the control line 233 is pulled up to +3.3 [V] at a downstream side, when the push switch serving as the power switch 311 is not pressed, the control line 233 serving as the output becomes “High”. Accordingly, a pulse signal is generated.

In an ON-pulse generation unit or generator 601, a signal on the control line 233 and the ON signal 235 from the power control unit 216 are input to NOR logic, and an output of the NOR logic is connected, via a transistor, to the control line 232 to form a wired-OR connection, thereby serving as an output on the control line 234.

Accordingly, only when the print server 102 is in an “OFF” state, an operation of the power switch 311 is detected and an ON pulse signal is output to the power control unit 216.

### Timing Chart Example of Switch Control Unit that May be Used

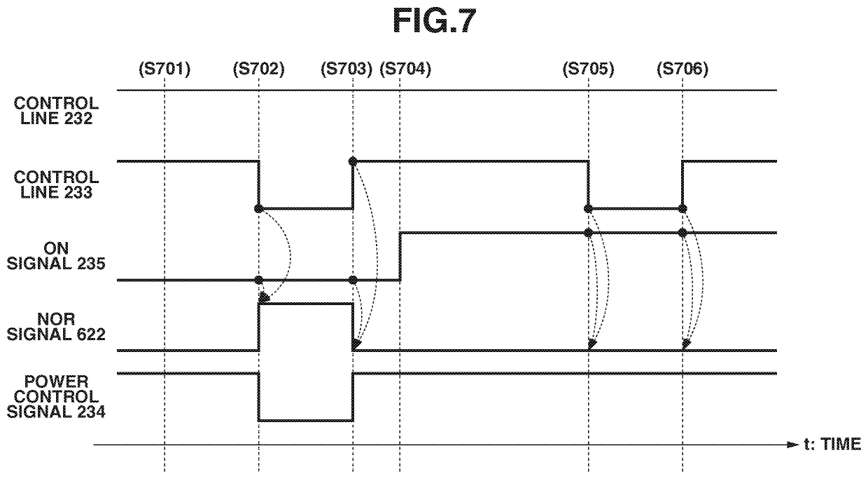

A description will be provided below for at least one embodiment of an operation of the switch control unit 231 with reference to a timing chart of FIG. 7.

In FIG. 7, step S701 indicates an initial state of the switch control unit 231.

The power switch 230 is not pressed, and the control line 232 is pulled up to +3.3 [V] and is therefore “High”.

The power switch 311 is also not pressed, and the control line 233 is pulled up to +3.3 [V] and is therefore “High”. Since the control line 233 is “High”, a NOR signal 622 is “Low”.

A power control signal 234 obtained by a wired-OR connection between the control line 232 and the NOR signal 622 as an output signal of the switch control unit 231 is “High”.

In the initial state, the ON signal 235 from the power control unit 216 is in an “OFF” state.

In step S702, when the power switch 311 is pressed, the control line 233 becomes “Low” by being connected to the pulled-down input side, and two inputs of the NOR logic both become “Low”. As a result, the NOR signal 622 becomes “High”, the transistor is turned on, the control line 232 is grounded, and the power control signal 234 is “Low”.

In step S703, when the power switch 311 is released, the pulled-up control line 233 becomes “High”. Since an input of the NOR logic becomes “High”, an input to the transistor becomes “Low”, and the power control signal 234 becomes “High”.

As described above, a negative-logic pulse signal is generated on the power control signal 234 by operation of the push switch serving as the power switch 311, and the negative-logic pulse signal is input to the power control unit 216.

In step S704, the pulse signal described above is detected by the power control unit 216, the print server 102 transitions to an ON state, and the ON signal 235 becomes “High”.

Steps S705 and S706 in FIG. 7 illustrate an operation of the ON-pulse generation unit or generator 601 when the power switch 311 is pressed while the print server 102 is in an ON state.

In step S705, when the power switch 311 is pressed, the control line 233 becomes “Low”. However, since the ON signal 235 remains “High” in the ON state, an input of the NOR logic remains “Low”, and the power control signal 234 remains “High”. Accordingly, when the print server 102 is in an ON state, an operation of the power switch 311 is ignored, the MFP 103 is turned off, and the print server 102 remains on.

In one or more embodiments or in one or more additional embodiments, NOR logic is used. However, the present disclosure is not limited to this configuration, and logic may be configured using another complete set (AND, OR, NOT, NAND, or the like). Further, a monostable multivibrator may be used to generate a pulse having a predetermined length by a push switch.

With the above configuration(s), an ON/OFF state of power of the print server 102 may be switched by the power switch 311 of the MFP 103. Accordingly, the MFP 103 and the print server 102 may be turned on at the same time. Further, after the print server 102 is turned on, an operation of the power switch 311 of the MFP 103 is ignored, thereby keeping the print server 102 turned on.

### ONE OR MORE OTHER EMBODIMENTS

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2025-046054, filed Mar. 19, 2025, which is hereby incorporated by reference herein in its entirety.

What is claimed is:

1. A printing system comprising:
an image forming apparatus including a first power controller connected to a first power switch; and
a print processing apparatus in which a second power switch is connected to a second power controller via a switch controller,
wherein the second power controller is connected to the second power switch and the first power switch via the switch controller, and
wherein the second power controller is configured to, based on detecting that either the second power switch or the first power switch has been turned on, execute control to turn on power of the print processing apparatus.

2. The printing system according to claim 1, wherein the first power switch is a rocker switch, and the second power switch is a push switch.

3. The printing system according to claim 2, wherein the switch controller includes a wired-OR connection between (i) an output of a pulse generator connected to an output of the first power switch and (ii) an output of the second power switch.

4. The printing system according to claim 3, wherein the pulse generator includes a delay circuit and AND logic.

5. The printing system according to claim 1, wherein the first power switch and the second power switch are each a push switch.

6. The printing system according to claim 5, wherein the switch controller includes a wired-OR connection between (i) an output of NOR logic to which a signal output from the second power controller and an output of the first power switch are connected and (ii) an output of the second power switch.

7. A print processing apparatus comprising:
a switch controller switch between an output of a first power switch of an image forming apparatus and an output of a second power switch are connected to a second power controller; and
a controller configured to execute, based on detection by the second power controller that either the first power switch or the second power switch has been turned on, control to turn on power of the print processing apparatus.

8. A control method for a print processing apparatus including a second power controller to which an output of a first power switch of an image forming apparatus and an output of a second power switch are connected via a switch controller, the control method comprising:
performing control, by the second power controller, to turn on power of the print processing apparatus based on the second power controller detecting that either the first power switch or the second power switch has been turned on.
